(19) United States
(12) Patent Application Publication
(10) Pub. No.: US 2007/0171971 A1
(43) Pub. Date: Jul. 26, 2007

(54) Method for coding and decoding an image sequence encoded with spatial and temporal scalability

(76) Inventors: Edouard Francois, Bourg Des Comptes (FR); Guillaume Boisson, Rennes (FR); Jerome Vieron, Bedee (FR); Gwenaelle Marquant, La Chapelle Chaussee (FR); Philippe Robert, Thorigne Fouillard (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/590,332

(22) PCT Filed: Feb. 21, 2005
(86) PCT No.: PCT/FR05/50108

§ 371 Date: Aug. 23, 2006

(30) Foreign Application Priority Data
Mar. 2, 2004 (FR) 0450419

(51) Int. Cl. H04N 7/12; H04B 1/66

(52) U.S. Cl. 375/240.12; 375/240.29

(57) ABSTRACT

The method is characterized in that the resolution chosen for the motion information and the complexity of the interpolation filters used during a motion compensated filtering operation depend on a decoding scenario, namely the spatial and temporal resolutions and the bit-rate selected for the decoding or the corresponding temporal decomposition level or a combination of these parameters. The applications relate to the video coders/decoders known as “scalable” for example in the domain of video telephony or video transmission over internet.

The invention relates to a method of video coding and decoding of a picture sequence coded with spatial and temporal scalability, by hierarchical temporal analysis exploiting the motion compensated temporal filtering.

The scope is that of video compression based on spatial and/or temporal scalability diagrams also known as “scalables”. This involves for example a 2D+t wavelet coding comprising a motion compensated temporal filtering.

A scalable coding-extraction-decoding system is illustrated in FIG. 1.

The source pictures are transmitted to a scalable video coding circuit 1. The original bitstream obtained is processed by an extractor 2 to give an extracted bitstream. This bitstream is decoded by the decoding circuit 3 which supplies the decoded video at the output.

The scalability enables an original bitstream to be generated from which one can extract binary sub-streams adapted to sets of data such as flow, spatial resolution, temporal frequency, etc. For example, if the original scalable bitstream was generated from a 25 Hz, 720×480 pixel resolution video sequence without any bitstream constraints, a sub-bitstream, for example with a 360×240 pixel resolution of parameters 1 Mb/s, 12.5 Hz, itself scalable, can be obtained after extracting the suitable data from this bitstream. The decoding of this extracted sub-bitstream will generate a 12.5 Hz video of size 360×240 pixels.

In existing approaches to scalable video compression, the coding and decoding proceed in an identical manner, without taking into account operating conditions such as the level of temporal decomposition, bit-rate, spatial resolution of the decoded video . . . In particular, if the decoding involves motion compensation between pictures, this compensation is applied identically, without taking into account the size of the pictures or the bit-rate of the video to be decoded. This results in a degraded picture quality, particularly when the picture resolution becomes small with respect to the size of the interpolation filters used for the motion compensation.

The invention aims to overcome the disadvantages described above.

One of the purposes of the invention is a decoding method of a picture sequence coded with spatial and temporal scalability, the coded data comprising motion information, comprising a hierarchical temporal synthesis step carrying out a motion compensated temporal filtering, or MCTF, of pictures at a frequency decomposition level, from the said motion information, to provide pictures at a lower decomposition level, characterized in that, during a motion compensated temporal filtering operation, the resolution chosen for the use of the motion information and the complexity of the interpolation filters used depend on the decoding scenario, namely spatial and temporal resolutions and the bit-rate selected for the decoding or else the corresponding temporal decomposition level or a combination of these parameters.

According to a particular implementation, the number of coefficients of the interpolation filter used for the motion compensation depends on the decoding scenario or the temporal decomposition level.

According to a particular implementation, the hierarchical temporal synthesis is a decoding of wavelet coefficients with motion compensated filtering.

The invention also relates to a coding method of a picture sequence of a given spatial resolution, with spatial and temporal scalability, comprising a hierarchical temporal analysis step carrying out a motion compensated temporal filtering, or MCTF, of pictures at a frequency decomposition level, from motion information between these pictures, to provide pictures at a higher decomposition level, characterized in that, during a motion compensated temporal filtering operation, the resolution chosen for the use of the said motion information and the complexity of the interpolation filters used depend upon the said spatial resolution of the source pictures or the corresponding temporal decomposition level.

The method, according to a particular implementation, comprises a motion estimation step computed between two pictures at a given level of decomposition to perform the motion compensation and in that the computation accuracy of the motion estimation depends on the temporal decomposition level or the said spatial resolution of the source pictures.

The temporal analysis step is for example a wavelet coding operation with motion compensated filtering.

The invention also relates to a decoder for the implementation of the previously described decoding method, characterized in that it comprises a motion configuration choice circuit to determine the motion resolution and the interpolation filter to use in the motion compensation for the motion compensated filtering, depending on the decoding scenario, namely the spatial and temporal resolutions and the bit-rate selected for the decoding or the corresponding temporal decomposition level or a combination of these parameters.

The invention also relates to a coder for the implementation of the previously described coding method, characterized in that it comprises a motion configuration choice circuit to determine the interpolation filter to be used by the temporal analysis circuit for the motion compensation depending on the said spatial resolution of the source pictures or the corresponding temporal decomposition level.

According to a particular embodiment, the coder is characterized in that it comprises a motion configuration choice circuit to determine the accuracy of the motion computed by the motion estimation circuit, depending on the said spatial resolution of the source pictures or of the corresponding temporal decomposition level.

The accuracy of the motion and the interpolation filters used for the motion compensation in the coding and decoding process are adapted according to different parameters, such as the temporal decomposition level at which one proceeds. These filters are adapted, for the decoding, at the bit-rate of the decoded flow, to the spatial or temporal resolution of the decoded video. Owing to this adaptive motion compensation, the quality of the pictures is improved, the complexity of the processing operations is reduced.

Other specific features and advantages will emerge more clearly from the following description, the description provided as a non-restrictive example and referring to the annexed drawings wherein:

FIG. 1 a coding system according to prior art,

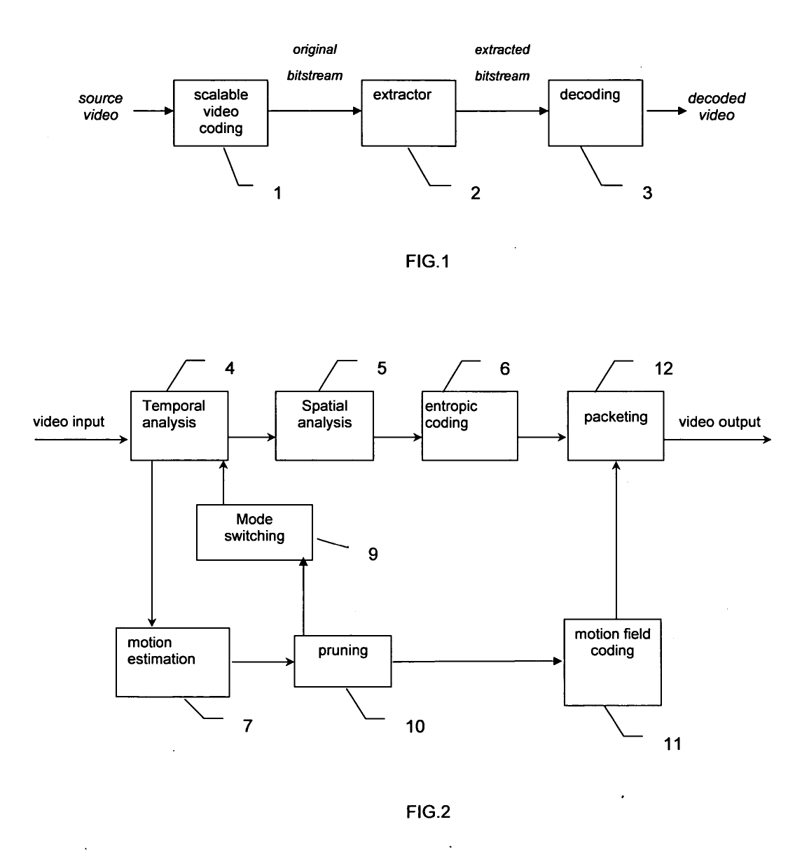

FIG. 2, a simplified coding diagram,

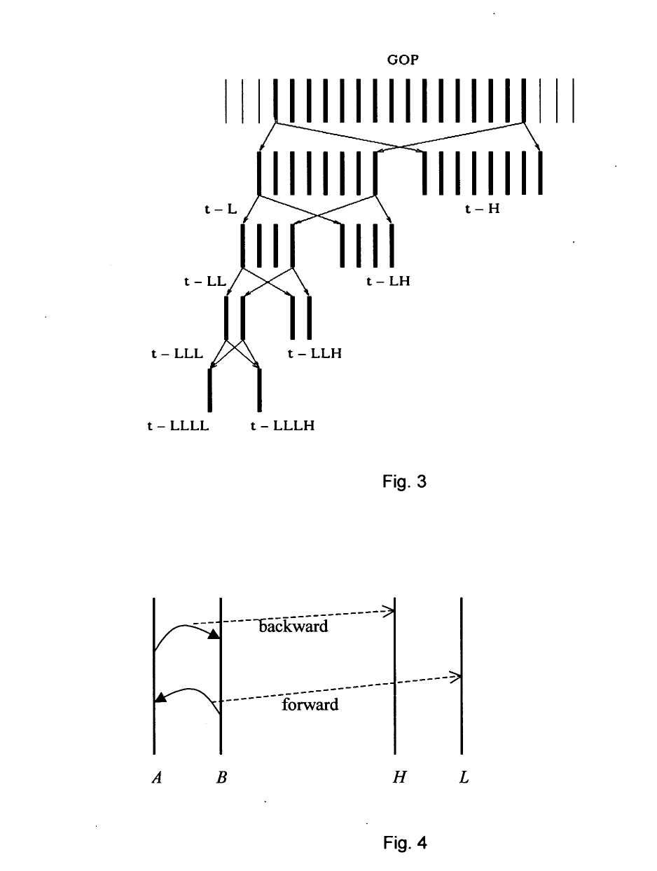

FIG. 3, a temporal filtering of GOP,

FIG. 4, a temporal filtering on two pictures,

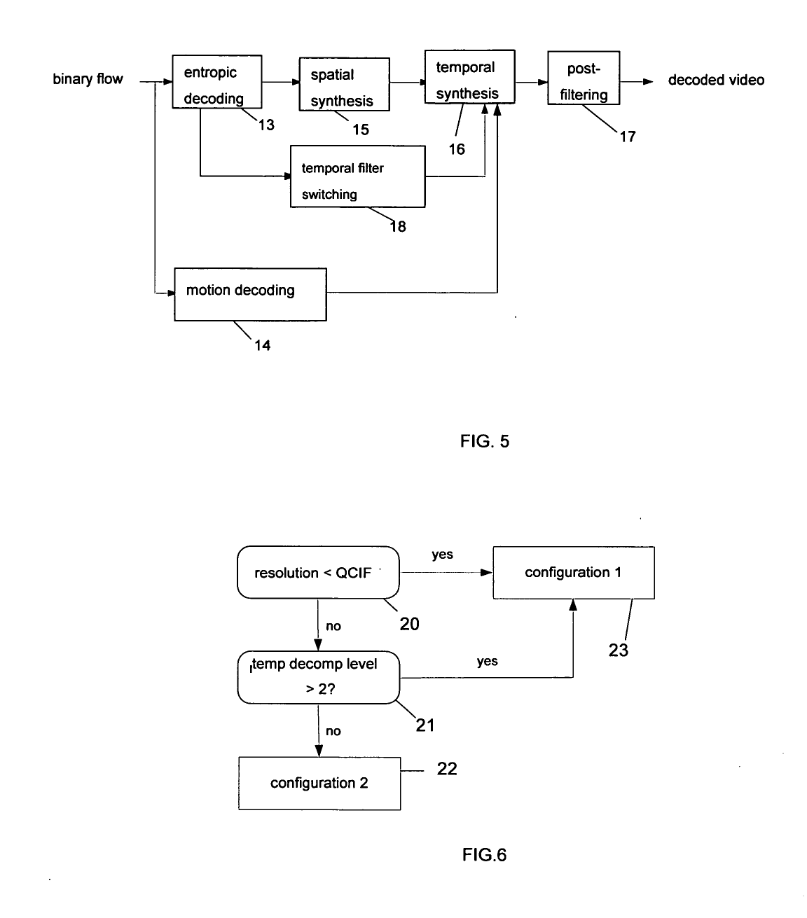

FIG. 5, a decoding circuit,

FIG. 6, a flow chart for the motion configuration choice,

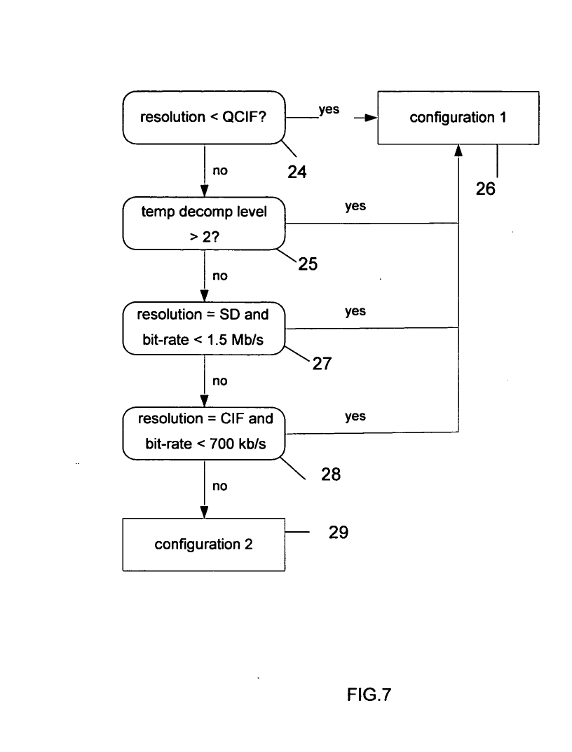

FIG. 7, a second flow chart for the motion configuration choice.

We consider a 2D+t wavelet based coding/decoding diagram operating a wavelet analysis/synthesis along the motion trajectories. The system operates on group of pictures or GOPs.

The overall architecture of the coder is described in FIG. 2.

The source pictures are transmitted to a temporal analysis circuit 4 that carries out a motion compensated temporal analysis or MCTF, acronym of motion compensation temporal filtering, to obtain the different frequency temporal bands. The picture are transmitted to a motion estimation circuit 7 that computes the motion fields. These fields are sent to a “pruning” circuit 10 that carries out a “pruning” or a simplification of the motion information computed by the motion estimation circuit to control the cost of the motion. The motion fields simplified in this manner are sent to the temporal analysis circuit so as to define the analysis filters. They are also sent to a coding circuit 11 that codes the simplified motion fields.

The resulting pictures of the temporal analysis are sent to a spatial analysis circuit 5 that performs a subband coding of the low bandwidth picture and of the high bandwidth pictures obtained by the temporal analysis. The spatio-temporal wavelet coefficients thus obtained are finally coded by an entropic coder 6. This coder provides a set of binary packets at its output corresponding to the layers of superposed scalabilities, both in quality, in spatial and temporal resolutions. A packetizer 12 performs the fusion of these binary packets with the motion data coming from the coding circuit 11 to provide the final scalable bitstream.

The pictures at the different levels of temporal decomposition are sent by the temporal analysis circuit 4 to the motion estimation circuit 7 comprising a first motion configuration choice circuit. This circuit, not shown in the figure, defines the operating conditions of the motion estimation circuit according to the different decomposition levels of the pictures. Optionally, the motion information, once simplified via the pruning circuit 10, is sent to the temporal analysis circuit through a mode switching circuit 9. This circuit is used to test the quality of the motion estimation by testing for example the number of pixels connected between the current picture and the previous picture, to a given decomposition level, and can impose on the temporal analysis circuit an intra mode coding or a predictive mode coding, that is a filtering of the current picture with the following picture and not the previous picture, when this motion quality is insufficient. The choice between the intra and predictive mode depends for example on the quality of the motion estimation between the current picture and the following picture. The temporal analysis circuit comprises a second motion configuration choice circuit, also not shown in the figure, that determines, according to the decomposition levels of the pictures and/or the spatial resolution of the source picture, the configuration to adopt for the motion compensation used in this temporal analysis.

FIG. 3 shows in a summary manner the motion compensated temporal filtering operations performed by the temporal analysis circuit 4, with a 4-level decomposition for GOPs comprising in this example, 16 pictures shown in thick lines.

The filtering mode used is called “lifting”. Instead of using a complex filtering for the wavelet coding, using a linear filter of a great length, in our example the filtering will be carried out on a group of 16 pictures, this filtering method consists, in a known manner, of “factorising” the filter by using limited length filters, for example two if it is decided to filter the samples two by two, this filtering being renewed for each decomposition level. One therefore considers the case in which the filtering in the direction of motion is carried out on pairs of pictures. The low frequency and high frequency filtering on each of the pairs of the GOP, produces respectively 8 low temporal frequency images (t-L) and 8 high temporal frequency images (t-H) at the first temporal decomposition level.

The low temporal frequency images are then decomposed again according to the same method. The low pass filtering of these pictures provides 4 new low temporal frequency pictures t-LL and the high pass filtering of these same pictures provides 4 high temporal frequency pictures t-LH. The third decomposition level provides 2 low temporal frequency pictures t-LLL and 2 high temporal frequency pictures t-LLH. The fourth and last level provides a low temporal frequency picture t-LLLL and a high temporal frequency picture t-LLLH.

This temporal decomposition is a 5 band temporal decomposition that therefore generates 1 t-LLLL picture, 1 t-LLLH picture, 2 t-LLH pictures, 4 t-LH pictures, and 8 t-H pictures per GOP of 16 pictures. The t-L, t-LL, t-LLL pictures and naturally the original pictures are ignored for the downstream coding as they are at the origin of the decomposition into subbands to provide de-correlated pictures at each level. This decomposition thus enables a new distribution of the energy by generating a useful picture with a low temporal frequency t-LLLL, which represents an average of the set of the GOP and in which is concentrated the energy and four levels of pictures of low energy high temporal frequency pictures, namely 5 frequency bands. It is these pictures that are sent to the spatial analysis circuit for spatial decomposition into subbands.

To perform the filtering, a motion field is estimated between each pair of pictures to be filtered and this for each level. This is the function of the motion estimator 7.

The filtering of a pair of source pictures A and B consists by default of generating a temporal low frequency picture L and a temporal high frequency picture H, according to the following equations:

$$\{ \begin{matrix}L = ( B + MC ( A ) ) / \sqrt{2} \\ H = ( A - MC ( B ) ) / \sqrt{2}\end{matrix}$$

where MC(I) corresponds to the motion compensated picture I.

The sum relates to the low pass filtering, the difference, to the high-pass filtering.

FIG. 4 is a simplified illustration of the temporal filtering of the two successive pictures A and B, the picture A being the first picture according to the time axis and according to the order of display, giving a low frequency picture L and a high frequency picture H.

The motion estimation is performed with respect to a reference picture, from the current picture to the reference picture. For each pixel of the current picture, a search is made for its corresponding pixel, if it exists, in the reference picture, and the corresponding motion vector is assigned to it. The pixel of the reference picture is then said to be connected.

Obtaining the picture L requires a motion compensation of the picture A. This compensation is achieved by motion estimation of the picture B to the picture A taking A as the reference picture, a motion and therefore a vector thus being assigned to each pixel of the picture B. The value of a pixel of L equals, at the nearest shape factor, the sum of the luminance of the corresponding pixel of the picture B and the luminance of the pixel or subpixel of A pointed by the motion vector assigned to the corresponding pixel of the picture B. An interpolation is necessary when this vector does not point to a pixel of the picture A. This concerns forward prediction from a past reference picture and computation of forward vectors by referring to the MPEG standard.

Obtaining the picture H requires a motion compensation of the picture B. This compensation is achieved by motion estimation of the picture A to the picture B taking B as the reference picture, a motion and therefore a vector thus being assigned to each pixel of the picture A. The value of a pixel of H equals, at the nearest shape factor, the difference of the luminance of the corresponding pixel of the picture A and the luminance of the pixel or subpixel of B pointed by the motion vector assigned to the corresponding pixel of the picture A. An interpolation is necessary when this vector does not point to a pixel of the picture B. This concerns backward prediction from a future reference picture and computation of backward vectors by referring to the MPEG standard.

In a practical manner, only a motion vector field is computed, from A to B or from B to A. The other motion vector field is deducted from the first, generating non-connected pixels, that is not assigned a motion vector and corresponding to holes in the reverse motion vector field.

In a practical manner, the low and high frequency pictures are computed as follows:

$$\{ \begin{matrix}H = \frac{B - {MC}_{A ← B} ( A )}{\sqrt{2}} \\ L = \sqrt{2} \cdot A + {MC}_{A ← B}^{- 1} ( H )\end{matrix}$$

This filtering, equivalent to the filtering described, consists in first calculating the picture H. This picture is obtained from point to point difference of the picture B and the motion compensated picture A. Hence, a certain value is removed from a pixel B, interpolated if necessary, pointed by the displacement vector in A, motion vector computed during the motion estimation of the picture B to the picture A.

The picture L is then deducted from the picture H and no longer the picture B, by addition of the picture A to the reverse motion compensated picture H. MC⁻¹_{A←B}(H) corresponds to a motion “decompensation” of the picture (H). Hence, one adds, to a pixel of A or more exactly to a standardised value of the luminance of the pixel, a certain value, interpolated if necessary, located, in the picture H, at the base of a displacement vector B to A and pointing the A pixel.

The same reasoning can be applied at the level of a picture block instead of a pixel.

The motion estimation circuit 7 operates for example a motion estimation algorithm by block matching. A current block picture is correlated to the blocks of a search window in the reference picture to determine the motion vector corresponding to the best correlation. This search is carried out not only on the blocks of the search window obtained by successive horizontal and vertical displacements of a pixel but also on the interpolated blocks if the accuracy required is less than a pixel. This interpolation consists in computing the luminance values of the subpixels for the generation of picture blocks obtained by successive displacements of a value less than the distance between two pixels. For example, for an accuracy of a quarter of a pixel, a correlation test is performed every quarter of a pixel, horizontally and vertically. This interpolation uses filters called motion estimation interpolation filters.

The pictures for which a motion compensated temporal filtering is to be carried out are sent to the motion estimator 7 so that it can estimate the motion between two pictures. This circuit comprises a first motion configuration choice circuit that receives, in addition to the decomposition level information of the pictures, other information such as the spatial resolution of the source pictures. This circuit decides on the motion configuration according to this level and/or the spatial resolution. Hence, for example, the accuracy in the computation of the motion values depends on the temporal decomposition level of the pictures processed. This accuracy is all the lower as the decomposition level is high. The interpolation filters of the motion estimator are configured to be adapted to the motion accuracy. A configuration example is given below.

The temporal analysis circuit 4, as indicated above, realizes motion compensations for the temporal filtering of the pictures. These motion compensation operations require interpolation operations using interpolation filters, and this for each level of decomposition. The second motion configuration choice, in this temporal analysis circuit, which can be different from the first, implements a processing algorithm adapting the accuracy of the motion and the complexity of the interpolation filter for the motion compensation according to the temporal decomposition level of the pictures to motion compensate. As for the first motion configuration choice circuit, these different adaptations or configurations can also depend on the spatial resolution of the source pictures processed.

Naturally, a coder only comprising one of these configuration choice circuits falls within the scope of the invention.

A decoder according to the invention is described in FIG. 5. The binary flow received by the decoder is transmitted at the input of an entropic decoding circuit 13 that carries out the reverse operations of the entropic coding circuit of the coder. Among other things, it decodes the spatio-temporal wavelet coefficients and, if necessary, the coding modes. This binary flow is sent in parallel to the input of a motion decoding circuit 14 that decodes the motion fields received in the binary flow to send them to the temporal synthesis circuit. The entropic decoding circuit 13 is linked to a spatial synthesis circuit 15 that reconstructs the images corresponding to the different temporal subbands. The temporal wavelet coefficients coming from the spatial synthesis circuit are sent to a temporal synthesis circuit 16 that reconstructs the output pictures from temporal synthesis filters. The temporal synthesis circuit comprises a motion configuration choice circuit, not shown in the figure, that determines, according to the decoding conditions and/or picture decomposition levels, the configuration to adopt for the motion compensation used in this temporal synthesis. The temporal synthesis circuit is linked to a post-processing circuit 17 whose output is the output of the decoder. This involves for example post-filtering enabling the artefacts such as the block effects to be reduced.

In the case where the coder uses other coding modes other than the MCTF mode, for example the intra mode and the predictive mode, a temporal filter switch mode is used to receive this coding mode information coming from the entropic decoding circuit 13 and to send it to the temporal synthesis circuit 16 that subsequently carries out the filter switches.

The motion configuration choice circuit receives the bit-rate, resolution, spatial and temporal resolution information and the temporal decomposition networks. From this information or an item of this information, it chooses, for the temporal synthesis, a motion compensation configuration. The temporal synthesis circuit adapts the interpolation filter according to this chosen configuration.

The binary flow bit-rate received by the decoder corresponds to the extracted bitstream. The scalable coder generally sends the highest bit-rate that is the original bitstream, as seen above, and the extractor, which can be controlled by the decoder, extracts the bitstream corresponding to the resolutions required. The bit-rate information received is available to the decoder.

The spatial, temporal and bit-rate information define a decoding scenario. This scenario depends for example on the display used by the decoder, the bit-rate available to receive the data. It is from this information and/or the temporal decomposition level that the temporal synthesis circuit is configured regarding the interpolation filters.

An example of adaptation of the accuracy of the motion and the interpolation filter that depends on this accuracy is given below, for the motion estimation operations of the coder or the motion compensation operations in the coder or decoder:

| configuration | accuracy of the motion | interpolation filters |
|---|---|---|
| 1 | ¼ pixel | Bilinear |
| 2 | ⅛ pixel | ¼ pixel by 8-coefficient FIR |
| | | interpolation, then ⅛ pixel by |
| | | bilinear interpolation |

The configuration filter 2 is very similar to the one used in the MPEG-4 part 10 standard (reference ITU-T Rec. H.264 ISO/IEC 14496-10 AVC).

FIG. 6 shows a decision flow chart implemented by the motion configuration choice circuit belonging to the temporal analysis circuit.

Step 20 determines if the resolution of the source picture supplied to the coder is less than that of the QCIF format, from Quarter Common Intermediate Format, and corresponding to 176 columns, 120 lines. In the affirmative, the next step is step 23 that decides on the configuration 1.

In the negative, the next step is step 21, which checks the temporal decomposition level. If this level is strictly greater than 2, the next step is step 23, the configuration 1 is chosen. Otherwise, the next step is step 22, which decides on the configuration 2.

FIG. 7 shows a decision flow chart for the decoder.

The step 24 determines whether the resolution of the picture supplied by the decoder and corresponding to the binary flow extracted is less than that of the QCIF format, 176 columns, 120 lines. In the affirmative, the next step is step 26 that chooses the configuration 1.

In the negative, the next step is step 25, which checks the temporal decomposition level. If this level is strictly greater than 2, the next step is step 26, the configuration 1 is used. Otherwise, the next step is step 27. This step 27 determines whether the resolution of the picture to decode is equal to that of the SD format, from Standard Definition, 720 columns, 480 lines and whether the bit-rate of the binary flow is less than 1.5 Mb/s. In the affirmative, the next step is the step 26, which decides on the configuration 1.

In the negative, the step 28 is the next step. This step 28 determines whether the resolution of the picture to decode is equal to that of the CIF format, 352 columns, 240 lines and whether the bit-rate is less than 700 kbits/s. In the affirmative, the next step is the step 26 that imposes the configuration 1.

In the negative, the configuration 2 is imposed on the temporal filtering circuits.

The interpolation filter is for example of 8-coefficient FIR type, acronym for Finite Impulse Response. The filtering is carried out by convolution, thus taking into account the luminances of the 4 pixels preceding and following the subpixel to be computed.

For different positions at the subpixel s at ¼, ½, and ¾, three different interpolation filters of the previous type can be used. The value of a coefficient n is given by the formula:

$$f ( n + s ) = {\sum }_{m = - 4}^{4} h ( m ) \frac{sin π ( n + s - m )}{π ( n + s - m )} , 0 < s < 1.$$

s is the subpixel position, s=¼, ½, or ¾, n is the number of the coefficient and h(m) the attenuation filter or Hamming window.

The FIR filter can be deduced by weighting by a Hamming window and truncation of these weighted filters.

$$For s = \frac{1}{4} ,$$

the coefficients are:
[−0.0110 0.0452 −0.1437 0.8950 0.2777 −0.0812 0.0233 −0.0053]

$$For s = \frac{1}{2 } ,$$

the coefficients are:
[−0.0053 0.0233 −0.0812 0.2777 0.8950 −0.1437 0.0452 −0.0110]

$$For s = \frac{3}{4 } ,$$

the coefficients are:
[−0.0105 0.0465 −0.1525 0.6165 0.6165 −0.1525 0.0465 −0.0105]

With these filters, one can interpolate to ¼, ½ and ¾ of a pixel. The interpolation is first done according to the horizontal dimension, then the vertical. The interpolation to ⅛ of a pixel is next carried out by a bilinear interpolation from the positions of the ¼ of a pixel.

The example of adaptation given above at the level of the coder can be applied in the same manner at the level of the decoder.

Generally, the principle is to use a limited accuracy of motion and simple interpolation filters when one operates with limited picture qualities, that is a low bit-rate, on pictures of a small size and at high temporal decomposition levels. Conversely, when one processes good quality pictures, high spatial resolution, high bit-rates, low temporal decomposition rates, one uses a high accuracy of motion and sophisticated interpolation filters. The justification for this principle is that when the pictures to filter are poor in frequency content or of limited resolution, it is not useful to use highly evolved interpolation filters or a very great accuracy of motion.

The applications of the invention relate to the video coders/decoders known as “scalable” used for data compression/decompression, for example in the domain of video telephony or video transmission over internet.

1. Decoding method of a picture sequence coded with spatial and temporal scalability, the coded data comprising motion information, comprising a hierarchical temporal synthesis step carrying out a motion compensated temporal filtering, or MCTF, of pictures at a frequency decomposition level, from the said motion information, to provide pictures at a lower decomposition level, wherein, during a motion compensated temporal filtering operation, the resolution chosen for the use of the motion information and the complexity of the spatial interpolation filters used for the motion estimation depend on a decoding scenario, namely spatial and temporal resolutions and the bit-rate selected for the decoding or else the corresponding temporal decomposition level or a combination of these parameters.

2. Method according to claim 1, wherein the number of coefficients of the interpolation filter used for the motion compensation depends on the decoding scenario or the temporal decomposition level.

3. Method according to claim 1, wherein the hierarchical temporal synthesis step is a decoding of wavelet coefficients with motion compensated filtering.

4. Coding method of a picture sequence of a given spatial resolution, with spatial and temporal scalability, comprising a hierarchical temporal analysis step carrying out a motion compensated temporal filtering, or MCTF, of pictures at a frequency decomposition level, from motion information between these pictures, to provide pictures at a higher decomposition level, wherein, during a motion compensated temporal filtering operation, the resolution chosen for the use of the said motion information and the complexity of the interpolation filters used depends upon the said spatial resolution of the source pictures or the corresponding temporal decomposition level.

5. Method according to claim 4, comprising a step of motion estimation computed between two pictures at a given level of decomposition to perform the motion compensation, the computation accuracy of the motion estimation depending on the temporal decomposition level or the said spatial resolution of the source pictures.

6. Method according to claim 4, wherein the hierarchical temporal analysis step is a wavelet coding with motion compensated filtering.

7. Decoder for the implementation of the method according to claim 1, comprising a motion configuration choice circuit to determine the motion resolution and the interpolation filter to use in the motion compensation for the motion compensated filtering, depending on the decoding scenario, namely the spatial and temporal resolutions and the bit-rate selected for the decoding or the corresponding temporal decomposition level or a combination of these parameters.

8. Coder for the implementation of the method according to claim 4, comprising a motion configuration choice circuit to determine the interpolation filter to be used by the temporal analysis circuit for the motion compensation depending on the said spatial resolution of the source pictures or the corresponding temporal decomposition level.

9. Coder for the implementation of the method according to claim 4, comprising a motion configuration choice circuit to determine the accuracy of the motion computed by the motion estimation circuit depending on the said spatial resolution of the source pictures or of the corresponding temporal decomposition level.
